(19) United States
(12) Patent Application Publication
(10) Pub. No.: US 2015/0369938 A1
(43) Pub. Date: Dec. 24, 2015

(54) SYSTEM AND METHOD FOR PROCESSING SEISMIC DATA

(71) Applicant: CHEVRON U.S.A. INC., San Ramon, CA (US)

(72) Inventors: Arturo E. Romero, JR., Sugar Land, TX (US); Michael G. Greene, Sugar Land, TX (US)

(21) Appl. No.: 14/840,227

(22) Filed: Aug. 31, 2015

Related U.S. Application Data
(63) Continuation-in-part of application No. 13/076,797, filed on Mar. 31, 2011.

(51) Int. Cl. G01V 1/36; G01V 1/30

(52) U.S. Cl. CPC G01V 1/36; G01V 1/307; G01V 2210/584

(57) ABSTRACT

A computer-implemented method for processing seismic data includes the determining, from the seismic data, a first amplitude attribute map at a first image depth corresponding to a shallow attenuating body, and a second amplitude attribute map at a second image or target depth. The first and second amplitude attribute maps are then normalized, and a ratio map is determined based on a ratio of the normalized first and second amplitude attribute maps. The ratio map is scaled to yield a scale factor map, which is then applied to the seismic data to compensate for effects of shallow overburden attenuation. The corrected seismic data may be used for subsurface characterization.

This application is a continuation-in-part of U.S. Ser. No. 13/076,797 filed Mar. 31, 2011.

### FIELD OF THE DISCLOSURE

This disclosure relates generally to the seismic data processing, and more particularly to a method and system for minimizing the effects of shallow overburden attenuation.

### BACKGROUND OF THE DISCLOSURE

Shallow overburden anomalies are known to have significant detrimental effects on seismic data quality. Such anomalies may include amplitude attenuation, frequency loss and wave front distortion as received (reflected) waves from deeper “target” levels of the subsurface travel through gas-charged channel complexes and hydrates at shallower regions. This may cause mis-positioning, dimmed amplitudes and/or lower bandwidth of the reflected seismic signals received from the target levels, thus impacting the quality of the subsurface characterization.

Conventional compensation methods for spatially-varying amplitude attenuation due to shallow bodies have been developed. See for example: “Turning ray amplitude inversion: Mitigating amplitude attenuation due to shallow gas,” SEG Annual Meeting Expanded Technical Program Abstracts with Biographies, vol. 21, pp. 2078-2081 (2002), by M. Deal, G. Matteucci, Y. Kim, and A. Romero; “Efficient compensation for attenuation effects using pseudo-Q migration,” SEG Annual Meeting Expanded Technical Program Abstracts with Biographies, vol. 27, pp. 2206-2210 (2008), by L. Bear, J. Liu and P. Traynin; “3-D tomographic amplitude inversion for compensating amplitude attenuation in the overburden,” SEG Annual Meeting Expanded Technical Program Abstracts with Biographies, vol. 27, pp. 3239-3243 (2008), by K. Xin, B. Hung, S. Birdus and J. Sun; “Compensation for the effects of shallow gas attenuation with viscoacoustic wave-equation migration,” SEG Annual Meeting Expanded Technical Program Abstracts with Biographies, vol. 21, pp. 2062-2065 (2002), by Y. Yu, R. Lu and M. Deal; and “True-amplitude prestack depth migration,” Geophysics, vol. 72, issue 3, pp. S155-S166, (June 2007), by F. Deng and G. McMechan. Successful application of these conventional methods, however, depends on the accuracy of the absolute attenuation or Q-field. Q-field estimation from amplitudes is computationally expensive and traditionally very difficult because amplitudes are affected by a number of factors such as propagation length, wavefront changes and reflectivities. Compensation methods that rely on Q-field often make simplifying assumptions such as using turning rays, limiting input data to far offsets, and weak attenuation conditions.

Other empirical compensation methods, including amplitude correction methods using spatially smoothed power sections and amplitude ratios have the potential to remove target amplitude information.

Therefore, a need exists to overcome the known shortcomings of conventional shallow overburden compensation methods. More specifically, a need exists for a shallow overburden compensation method that does not require prior knowledge of the Q-field, and which incorporates both overburden and target geology in the compensation. The compensation method should be consistent with amplitude-preserving workflows that enable improved quantitative seismic analysis for purposes of reservoir characterization.

### SUMMARY

A method is disclosed for processing seismic data corresponding to a subsurface area of interest. In accordance with an embodiment of the present invention, the method includes the steps of: determining, from the seismic data, a first amplitude attribute map at a first image depth or “layer”; determining, from the seismic data, a second amplitude attribute map at a second image depth; normalizing each of the first and second amplitude attribute maps. The normalized first and second amplitude attribute maps are used to determine a ratio map, which is then scaled and applied as scale factor map to the seismic data to compensate for effects of shallow overburden attenuation.

In accordance with another embodiment of the present invention, a corresponding system is provided processing seismic data corresponding to a subsurface area of interest. The system includes a data source containing the seismic data, and a computer processor in communication with the data source for processing the seismic data. The processor includes computer readable media having computer readable code for executing the steps of: determining, from the seismic data, a first amplitude attribute map at a first image depth; determining, from the seismic data, a second amplitude attribute map at a second image depth; normalizing each of the first and second amplitude attribute maps; determining a ratio map based on a ratio of the normalized first and second amplitude attribute maps; scaling the ratio map to generate a scale factor map; and applying the scale factor map to the seismic data to compensate for effects of shallow overburden attenuation.

In accordance with another embodiment of the present invention, an article of manufacture is provided that includes a computer readable medium having a computer readable code embodied therein adapted to execute a method for seismic data processing. The method includes the steps of: determining, from the seismic data, a first amplitude attribute map at a first image depth; determining, from the seismic data, a second amplitude attribute map at a second image depth; normalizing each of the first and second amplitude attribute maps; determining a ratio map based on a ratio of the normalized first and second amplitude attribute maps; scaling the ratio map to generate a scale factor map; and applying the scale factor map to the seismic data to compensate for effects of shallow overburden attenuation.

Advantageously, the present invention incorporates both overburden and target geology and allows for lateral and vertical scaling based on amplitude effects of the shallow attenuating bodies. Laterally-varying scale factors corresponding to different offsets/angles are applied to boost attenuated amplitudes within dim-out zones while preserving the non-attenuated amplitudes outside the dim-out zones. Furthermore, the method of the present invention is a straight-forward approach that corrects for attenuation based on amplitude ratios only without distinguishing scattering from inelastic attenuation, or taking into account converted waves, multiple energy or Q dependence on frequency.

### BRIEF DESCRIPTION OF THE DRAWINGS

A detailed description of the present invention is made with reference to specific embodiments thereof as illustrated in the appended drawings. The drawings depict only typical embodiments of the invention and therefore are not to be considered to be limiting of its scope.

FIG. 1 illustrates a system for processing seismic data configured to compensate for effects of shallow overburden attenuation in accordance with an embodiment of the present invention.

FIG. 2 illustrates a method for processing seismic data that compensates for effects of shallow overburden attenuation in accordance with an embodiment of the present invention.

FIG. 3 illustrates the effect of shallow overburden attenuators.

FIG. 4 illustrates the shadow effects of shallow attenuators for seismic images at near, mid and far angles.

FIGS. 5a and 5b illustrates exemplary angle dependent and offset dependent implementations in accordance with the present invention.

FIG. 6 illustrates exemplary shallow and deep amplitude attribute maps, and corresponding scale factor map.

FIG. 7 illustrates a comparison of far stack seismic images with and without compensation for shallow overburden compensation in accordance with the present invention.

### DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multi-processer computer processors system, hand-held devices, programmable consumer electronics, mini-computers, mainframe computers, supercomputers, and the like. The invention may also be practiced in distributed computing environments where tasks are performed by servers or other processing devices that are linked through one or more data communications networks. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

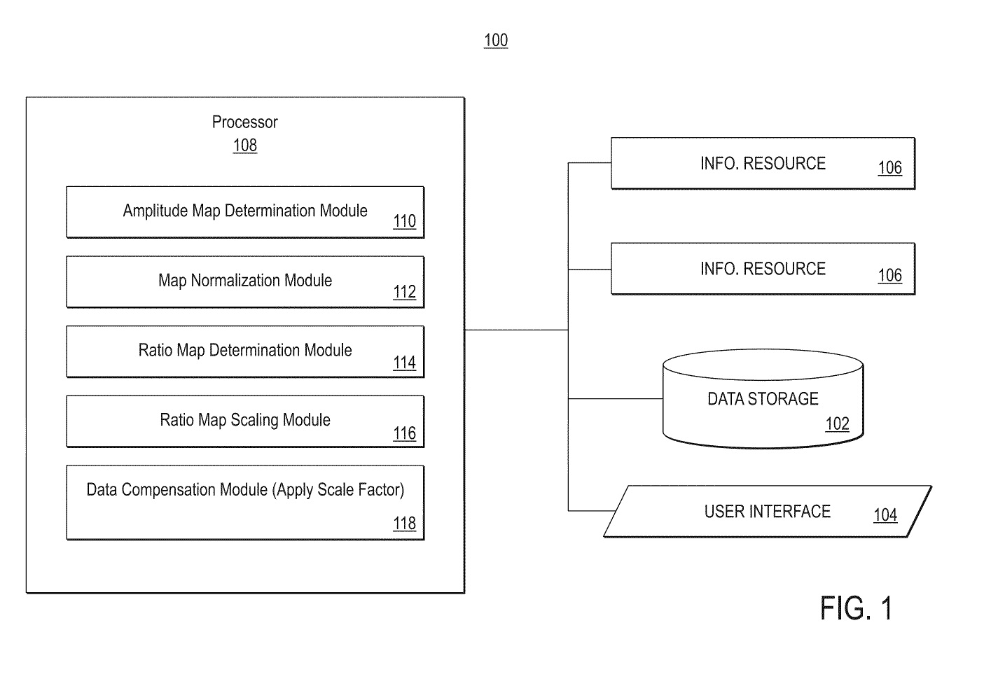

FIG. 1 shows a schematic of a system 100 for seismic data processing in accordance with an embodiment of the present invention. The system 100 includes a computer processor 108, a data storage 102, one or more optional information resources 106, and a user interface 104. The processor 108 is configured to provide information processing capabilities in the system 100, and as such may include one or more digital processors, analog processors, digital circuits, analog circuits, state machines and the like designed to electronically process information. Although the processor 108 is shown in FIG. 1 as a single entity, this is for illustrative purposes only. In some implementations, the processor 108 may include a plurality of processing units. These processing units may be physically located within the same device or computing platform, or the processor 108 may represent processing functionality of a plurality of devices operating in coordination.

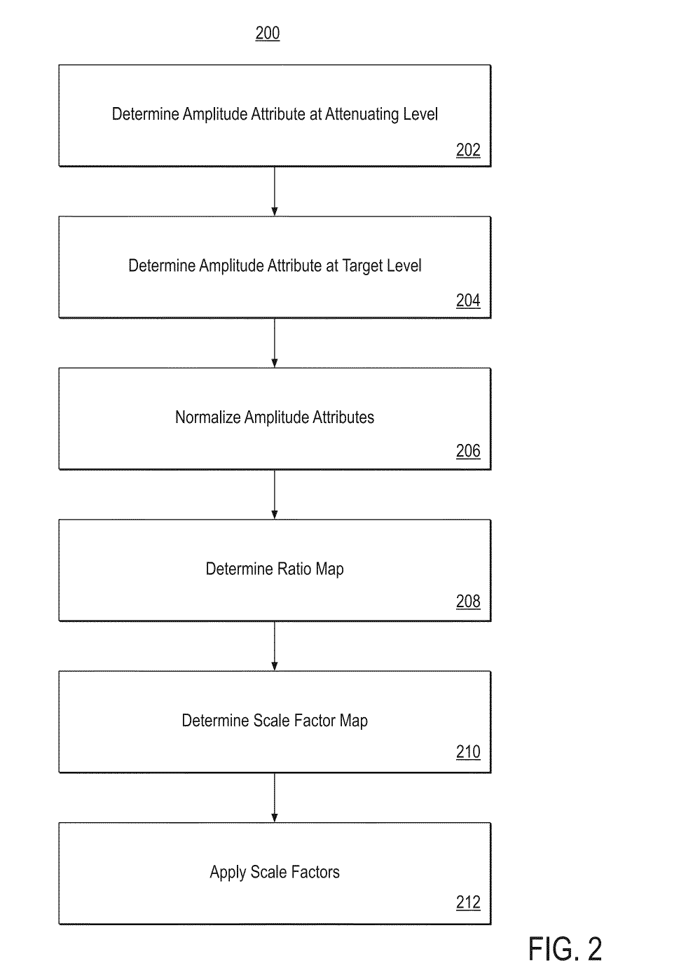

As is shown in FIG. 1, the processor 108 may be configured to execute one or more computer program modules or codes for implementing the method described below with reference to FIG. 2. The one or more computer program modules or codes may include an amplitude map determination module 110, an amplitude map normalization module 112, a ratio map determination module 114, a ratio map scaling module 116, and a seismic data compensation module 118. The processor 108 may be configured to execute modules 110-118 individually via software, hardware, firmware and/or some combination thereof, and/or other mechanisms for configuring processing capabilities on the processor 108.

It should be appreciated that although the modules 110-118 are illustrated in FIG. 1 as being co-located within a single processing unit, in implementations in which the processor 108 includes multiple processing units, one or more of the modules 110-118 may be located physically resident and distributed in the other modules. The description of the functionality provided by the different modules 110-118 is for illustrative purposes, and is not intended to be limiting, as any of the modules 110-118 may provide more or less the functionality required to implement the method of the present invention as described below with reference to FIG. 2. For example, one or more of the modules 110-118 may be eliminated, and some or all of its functionality may be provided by other ones of the modules 110-118. As another example, the processor 108 may be configured to execute one or more additional modules that may perform some or all of the functionality attributed below to one of the modules 110-118.

The data storage 102 may include electronic storage media for storing seismic data. The storage media may be integrally coupled with the system 100, i.e., substantially non-removable, and/or removably connectable to the system 100 via, for example, a port (e.g., USB port, a firewire port, etc.) or a drive (e.g., a disk drive, etc.). The data storage 102 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 102 may store software algorithms, information determined by the processor 108, information received via the user interface 104, information received from the information resources 106, and/or other information that enables the system 100 to function as described herein to execute the method described below with reference to FIG. 2. The electronic storage 102 may be a separate component within the system 100, or the electronic storage 102 may be provided integrally with one or more other components of the system 100 (e.g., the processor 108).

Seismic data stored by electronic storage 102 may include source wavefield data and receiver wavefield data. The seismic data may also include individual or multiple traces of seismic data (e.g., the data recorded on one channel of seismic energy propagating through the geological volume of interest from a source), offset stacks, angle stacks, azimuth stacks and/or other data.

The user interface 104 is configured to provide an interface between the system 100 and a user through which the user may provide information to and receive information from the system 100. This enables data, results, and/or instructions and any other communicable items, collectively referred to as “information,” to be communicated between the user and the system 100. As used herein, the term “user” may refer to a single individual or a group of individuals who may be working in coordination. Examples of interface devices suitable for inclusion in the user interface 104 include one or more of a keypad, buttons, switches, a keyboard, knobs, levers, a display screen, a touch screen, speakers, a microphone, an indicator light, an audible alarm, and/or a printer. In one embodiment, the user interface 104 actually includes a plurality of separate interfaces.

It is to be understood that other communication techniques, either hard-wired or wireless, are also contemplated by the present technology as the user interface 104. For example, the present technology contemplates that the user interface 104 may be integrated with a removable storage interface provided by the electronic storage 102. In this example, information may be loaded into the system 100 from removable storage (e.g., a smart card, a flash drive, a removable disk, etc.) that enables the user to customize the implementation of the system 100. Other exemplary input devices and techniques adapted for use with the system 100 as the user interface 104 include, but are not limited to, an RS-232 port, RF link, an IR link, modem (telephone, cable or other). In short, any technique for communicating information with the system 100 is contemplated by the present technology as the user interface 104.

Optional information resources 106 may include one or more additional sources of information, including but not limited seismic data. By way of non-limiting example, one of information resources 106 may include a field device used to acquire seismic data from a geological volume of interest, or databases or applications for providing “raw” and/or processed seismic data, including but not limited to pres-stack and post-stacked seismic data, and other information derived therefrom related to the geologic volume of interest. Other information may include velocity models, time horizon data, etc.

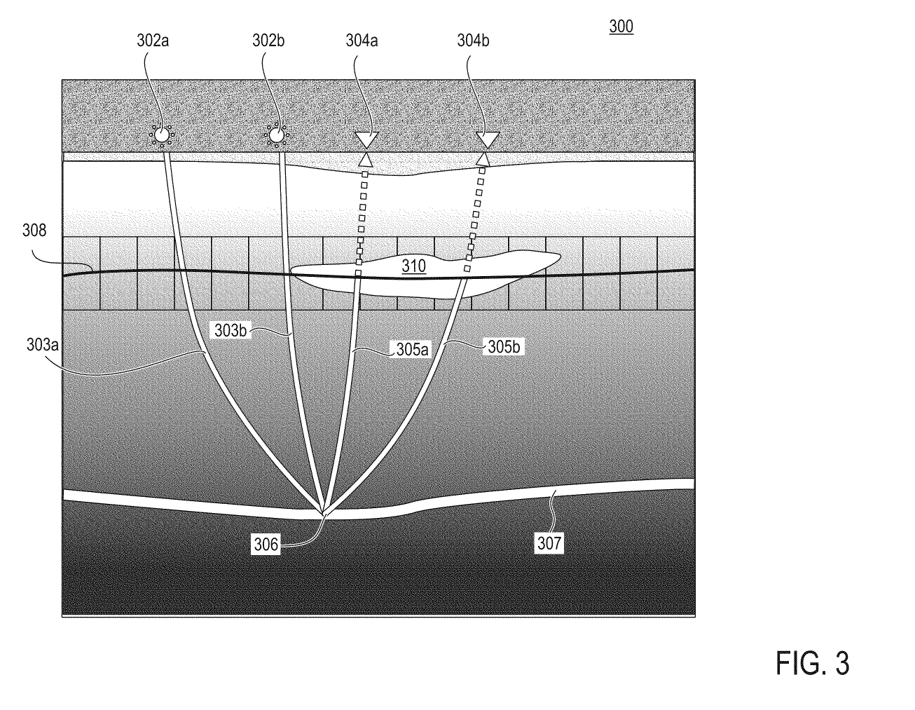

FIG. 2 is a flow diagram showing a method 200 of seismic processing in accordance with another embodiment of the present invention. With further reference to FIG. 3, the method 200 can be used to compensate Common Depth Point (CDP) seismic data amplitudes at a target 306 located at a target layer 307 for attenuating effects caused by shallow attenuating body 310 located at an attenuating layer 308. Due to the attenuating body 310, source wavefields 303a and 303b transmitted from near and far offset sources 302a and 302b, respectively, and reflected wavefields 305a and 305b received by near and far offset receivers 304a and 304b, respectively, may be attenuated and appear as “dim-out zones” in seismic images.

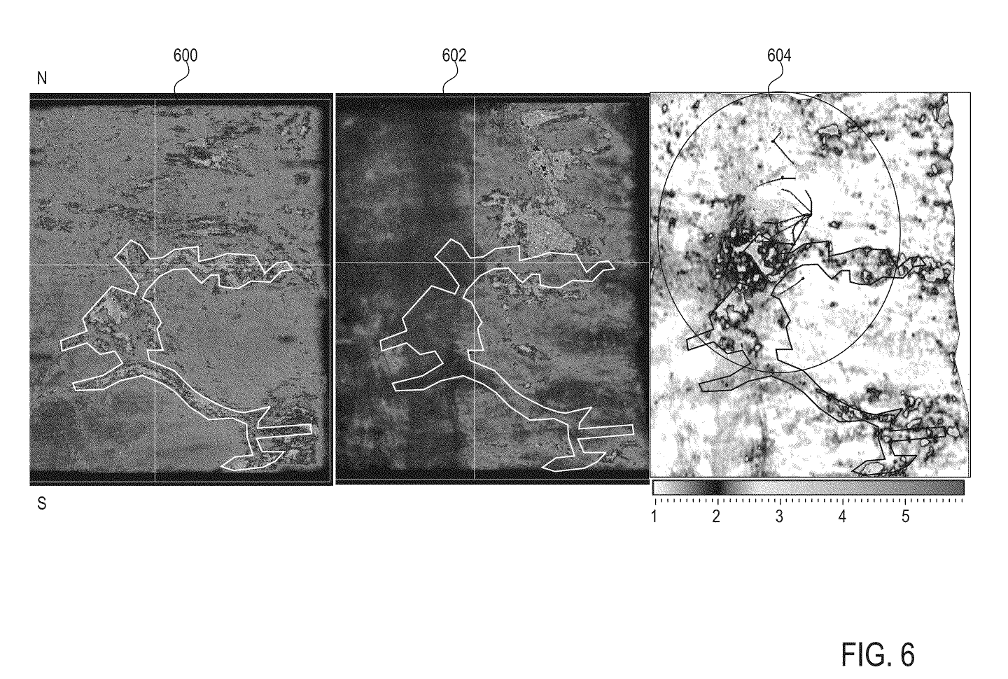

Referring again to FIG. 2, the method 200 includes the step 202 of determining an amplitude attribute map at a first attenuating (“shallow”) imaging depth (“layer”) from seismic data accessed from storage 102 and/or information resources 106. The attenuating layer 308 can be identified and isolated vertically and laterally, and a background reference amplitude level established using methods known and appreciated by those skilled in the art. Background reference levels, for example, can be maximum, minimum or average amplitude levels of the attenuating layer. The amplitude attribute for example may correspond to an actual, root mean square (RMS), maximum, minimum, absolute average of peak amplitudes, absolute average of minimum amplitudes, or other statistical representation of seismic data amplitude. An example of a shallow layer amplitude attribute map 600 using RMS values is shown in FIG. 6. Preferably, the amplitude attributes are extracted from near stack seismic data, however, far and full stack data may be used but may be susceptible to mis-positioning and fluid effects. Also, preferably, the accessed seismic data is already pre-processed and corrected for source/receiver response variations, vertical amplitude decay and geometric spreading.

Similarly, the seismic data is used to determine a second amplitude attribute map at a second “target” image depth, step 204. FIG. 6 shows an example of target amplitude attribute map 602 using RMS values. Optionally, one or both of the amplitude attribute maps may be spatially smoothed.

Next, the method 200 of the present invention includes the step 206 of normalizing each of the shallow and target layer amplitude attribute maps to a reference value. The reference value can be, for example, the average, maximum or minimum amplitude at the corresponding layer. Additional thresholding or “clipping” of one or both of the normalized amplitude attribute maps is performed to ensure the resulting scale factor map values do not boost amplitudes outside dim zones. For example, in the case of a shallow layer amplitude attribute map where the attribute is normalized to an average value, normalized amplitude attribute values having a value less than 1 can be set to a value of 1. In the case of a target layer amplitude attribute map where the attribute is an normalized to an average value, normalized amplitude attribute values having a value greater than 1 can be set to a value of 1.

Following the normalization step 206, a ratio map is determined based on a ratio of the normalized first and second amplitude attribute maps, step 208. This is done by taking the ratio of the first and second normalized amplitude attributes at each x, y location.

Ratio Map(x,y)=Norm First Amp Attr(x,y)/Norm Second Amp Attr(x,y) (Equation 1)

Forming ratio maps by taking the ratio of attributes at each x, y location is known (see, for example, Vetrici and Stewart, 1996, 3D Seismic Attributes, CREWES Research Report, Volume 8, pp. 45-1-45-30) but conventional methods take the ratio of two different attributes at the same layer. In this embodiment, the ratio taken at each x, y location is of the same attribute from two different layers. The ratio of the normalized shallow and target amplitude attributes will maximize the contributions from both the attenuating overburden zone and the target geology. Optionally, ratio map values having a value less than 1 can be set to a value of 1 to ensure resulting scale factor map values do not boost amplitudes outside dim zones. The ratio map is then scaled according to Equation 2, step 210, to derive the scale factor at any x,y location:

Scale Factor(x,y)=Ratio Map(x,y)/(Aₘᵢₙ*Aₘₐₓ); (Equation 2)

where Aₘᵢₙ is the minimum amplitude from the target layer amplitude attribute map and Aₘₐₓ is the maximum amplitude from the ratio map. The scale factor map (i.e., scaled ratio) characterizes the differential attenuation (dQ) (i.e., attenuation between shallow and target layers) at any given (x,y) location. The scale factor map determined in accordance with step 210 is equivalent to the inverse of differential attenuation (1/dQ), and therefore the method of the present invention does not require prior knowledge of absolute Q values.

Optionally, scale factors having a value greater than 1 can be set to a value according to Equation 3:

Scale Factor(x,y)=1+(Ratio Map(x,y)−1)/(Aₘᵢₙ*Aₘₐₓ). (Equation 3)

Next, step 212 of the present method includes the step of applying the scale factor map to the seismic data to compensate for effects of shallow overburden attenuation. Application to CDP gathers is now considered to illustrate the step 212 of the present invention.

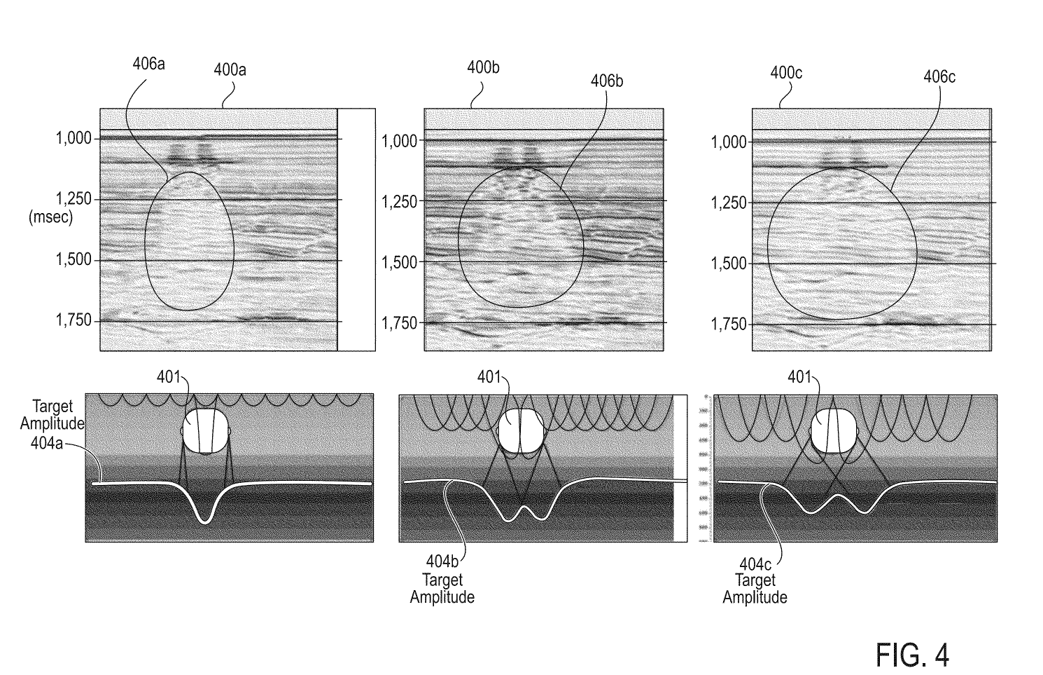

In the case of CDP gathers, corresponding ray paths may sample different areas of shallow overburden. As such, the total ray path that is to be compensated includes shot-side and receiver-side contributions. The amplitude for any given trace (CDP gather) can be restored by multiplying shot and receiver scale factors and the original trace. With reference to FIG. 4, the effects of shallow attenuating bodies are mapped to various locations deeper in the seismic section and are a function of the source/receiver offset or angle. For near offsets/angle stacks, as shown for example by 400a, the attenuated zone 406a often is directly below the attenuating body 401. See corresponding target amplitude 404a. For mid offset/angle stacks, as shown for example by 400b, the attenuation cone 406b opens beyond the extent of the attenuating body 401. See corresponding target amplitude 404b. For far offset/angle stacks, as show for example by 400c, the attenuation cone 406c widens farther, and depending on the size of the attenuating body 401 relative to the offsets, the zone directly beneath the attenuating body 401 may have normal amplitudes as the source and receiver side attenuation effects separate. See corresponding target amplitude 404c.

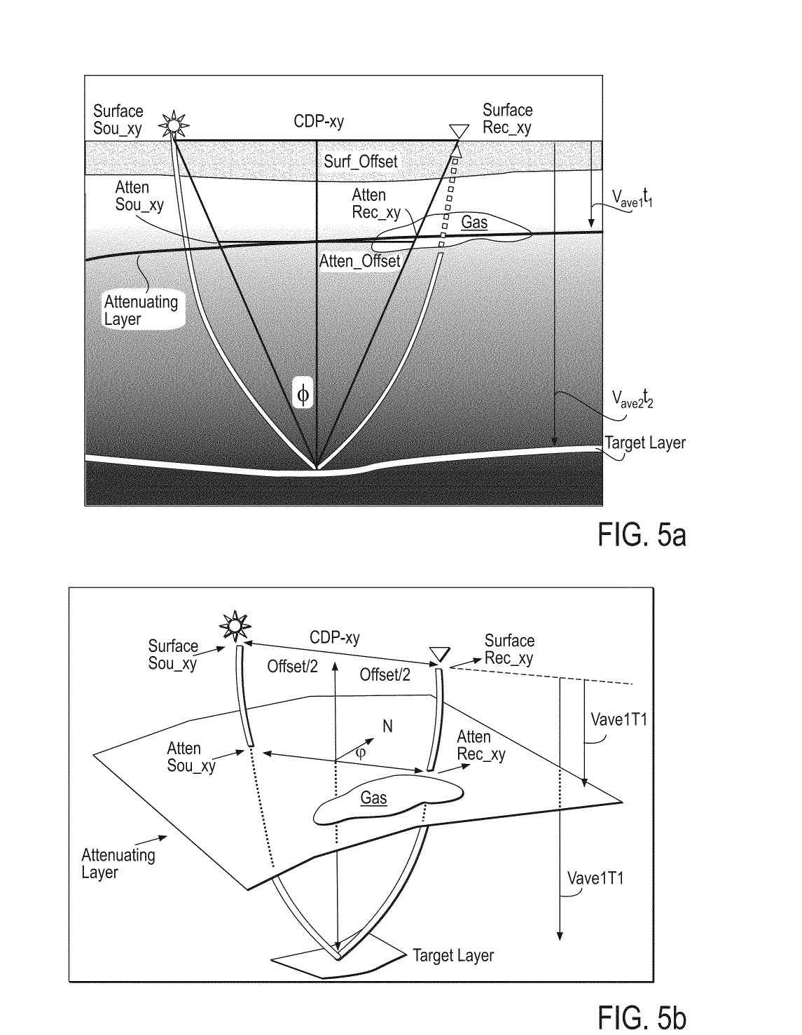

For pre-stack angle dependent seismic data, the equations provided below with reference to FIG. 5a can be applied to perform step 212 of the present method. In accordance with embodiment of step 212, the following input data is required for an angle-dependent implementation of step 212: the scale factor map derived in accordance with steps 202-210 of the present method at the attenuating layer; average velocity map at attenuating and target layers; time horizon of attenuating layer; time horizon of target layer; angle stack with trace header values: CDP x-location, CDP y-location, Inline number, and Xline number; and time gate application.

With reference to FIG. 5a, for each trace of pre-stack seismic data, surface offset and attenuation offset values are determined using straight ray approximation in accordance with Equations 4 and 5. For post-stack seismic data, angle φ corresponds to selected nominal angles corresponding to the stacked seismic data:

surf_offset=tan φ*0.5*vₐᵥₑ₂*t₂; (Equation 4)

atten_offset=tan φ*0.5*(vₐᵥₑ₂*t₂−vₐᵥₑ₁*t₁); (Equation 5)

where φ is a nominal angle of the stacked seismic data, vₐᵥₑ₁ is an average velocity at the attenuating layer, vₐᵥₑ₂ is an average velocity at the target layer, t₁ is a two-way time (down-going and up-going rays) at the attenuating layer, and t₂ is a two-way time at the target layer.

Next, the scale factor map is used to look up source and receiver scale factors sca_sou and sca_rec, respectively, at attenuating layer x and y locations (atten_sou_x, atten_sou_y, atten_rec_x, atten_rec_y) in accordance with Equations 6-9 below, where φ is azimuth as shown in FIG. 5b;

atten_sou_{—}x=CDP_{—}x−atten_offset*sin φ; (Equation 6)

atten_sou_{—}y=CDP_{—}y−atten_offset*cos φ; (Equation 7)

atten_rec_{—}x=CDP_{—}x+atten_offset*sin φ; (Equation 8)

atten_rec_{—}y=CDP_{—}y+atten_offset*cos φ; (Equation 9)

where φ azimuth from north of the seismic coordinate system (i.e., Inline).

Note, the above set of Equations 6-9 can be expressed in terms of Inline and Xline coordinates using Equation 10 and nominal CDP spacing, where the nominal CDP spacing is the average distance between CDP locations:

CDP_offset=atten_offset/CDP_spacing. (Equation 10)

Therefore, for a given Inline coordinate, the scale factor map is used to look up source and receiver scale factors sca_sou and sca_rec, respectively, at Inline and Xline coordinates in accordance with Equations 11-14 below:

atten_sou=Inline−CDP_offset; (Equations 11)

atten_rec=Inline+CDP_offset; (Equations 12)

atten_sou=Xline−CDP_offset; (Equations 13)

atten_rec=Xline+CDP_offset. (Equations 14)

Next, scale factors sca_sou and sca_rec are selected from the scale factor map corresponding to locations/coordinate as determined via Equations 6-9 or 11-14, and applied to each of the pre-stack (or post-stack) traces in accordance with Equation 15 (x, y, t), or Equation 16 (Inline, Xline, t), to compensate for shallow overburden effects. An additional time-varying weighting term is included to ensure that scale factors are not applied above or at the attenuating layer:

Scaled Trace(x,y,t)=Trace(x,y,t)*sqrt(sca_sou*sca_rec)*Weight(t); (Equation 15)

Scaled Trace(Inline,Xline,t)=Trace(Inline,Xline,t)*sqrt(sca_sou*sca_rec)*Weight(t). (Equation 16)

In accordance with another embodiment of step 212, the following input data is required for an offset-dependant implementation of step 212: the scale factor map derived in accordance with steps 202-210 of the present method at the attenuating layer; average velocity map at attenuating and target layers; time horizon of attenuating layer; time horizon of target layer; migrated gathers with trace header values: CDP x-location, CDP y-location, Inline number, and Xline number; and time gate application.

Next, the attenuation offset according to Equation 5 is modified using straight ray approximation in accordance with Equation 17, where vₐᵥₑ₁, t₁, vₐᵥₑ₂, and t₂ are obtained at CDP_x and CDP_y locations:

atten_offset=surf_offset*(vₐᵥₑ₂*t₂−vₐᵥₑ₁*t₁)/vₐᵥₑ₂*t₂; (Equation 17)

where vₐᵥₑ₁ is an average velocity at the attenuating layer, vₐᵥₑ₂ is an average velocity at the target layer, t₁ is a two-way time (down-going and up-going rays) at the attenuating layer, and t₂ is a two-way time at the target layer.

Scale factors sca_sou and sca_rec are then selected from the scale factor map corresponding to locations as determined below by Equations 6-9.

The scale factors selected from the scale factor map that the computed x-y locations are then applied to each of the pre-stack (or post-stack) traces in accordance with Equation 18 (x, y, t domain). An additional time-varying weighting term is included to ensure that scale factors are not applied above or at the attenuating layer;

Scaled Trace(x,y,t)=Trace(x,y,t)*sqrt(sca_sou*sca_rec)*Weight(t). (Equation 18)

As such, a map-based, target-oriented, angle/offset-varying overburden attenuation correction method and system has been disclosed. The present invention has advantages over conventional, empirical compensation methods in that the attenuation compensation is based solely upon a computed scaled ratio map (scale factor map) of shallow bright amplitudes to deep attenuated amplitudes corresponding to attenuated zones in deeper intervals. The scale factor map, of for example as shown by 604 in FIG. 6, is derived as a ratio of normalized shallow layer amplitude attributes and target layer attributes as shown for example in FIG. 6 by 600 and 602, respectively. The amplitude ratio boosts the anti-correlation relationship between shallow brights and deeper dim-out zones, at the same time de-emphasizing results from other combinations.

The embodiments illustrated by FIG. 1 and FIG. 2 produce seismic data that has had its amplitudes compensated for the effects of shallow attenuators. The corrected seismic data may be used to perform subsurface characterization, including characterization of potential hydrocarbon reservoirs. In general, such characterization may include structural interpretation and/or stratigraphic interpretation. The corrected seismic data is particularly useful for quantitative seismic analysis which relies on analysis of seismic amplitudes. An angle-dependent application will map shallow attenuating effects to the correct target location and avoid boosting amplitudes outside of attenuated zones. The restored amplitudes across angles enable improvement in quantitative amplitude variation with offset (AVO) analysis for reservoir prediction.

The embodiments illustrated herein may be used as part of seismic data processing workflows that preserve the seismic amplitudes to enable stratigraphic analysis that may result in analyses of fluid and/or rock types in the subsurface. Such analyses may be used for reservoir delineation, reserve estimation, and well planning.

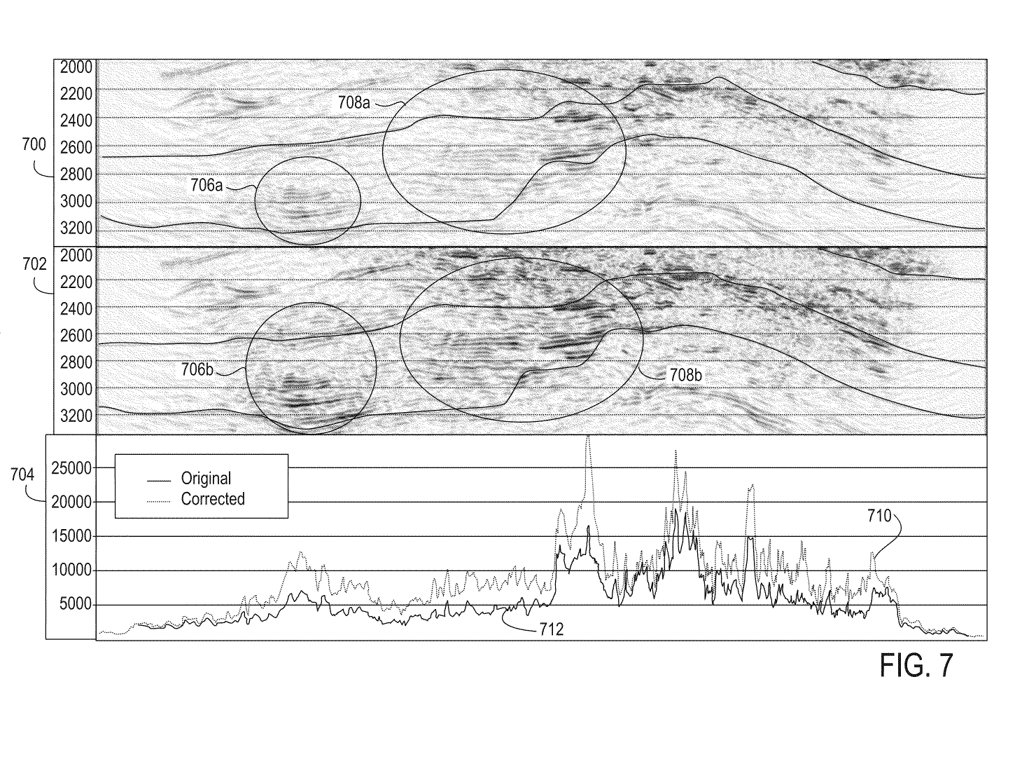

FIG. 7 shows a comparison of far stack seismic data with and without compensation, 700 and 702 respectively, for shallow overburden compensation in accordance with the present invention. Sections 706b and 708b show subsurface regions corresponding to locations where corresponding amplitudes have been boosted in comparison to regions 706a and 708b. The graph 704 shows original 712 and corrected (boosted) 710 RMS values over regions 706a-b and 708a-b.

Notwithstanding that the present invention has been described above in terms of alternative embodiments, it is anticipated that still other alterations, modifications and applications will become apparent to those skilled in the art after having read this disclosure. For example, it is to be understood that the present invention contemplates that, to the extent possible, one or more features of any embodiment can be combined with one or more features of any other embodiment. It is therefore intended that such disclosure be considered illustrative and not limiting, and that the appended claims be interpreted to include all such applications, alterations, modifications and embodiments as fall within the true spirit and scope of the invention.

What is claimed is:

1. A computer-implemented method for processing seismic data corresponding to a subsurface area of interest, the method comprising:
determining, via a computer processor and from the seismic data accessible by the processor, a first seismic amplitude attribute map at a first image depth comprising a seismic amplitude attribute determined at each x,y location at the first image depth;
determining, via the computer processor and from the seismic data accessible by the processor, a second seismic amplitude attribute map at a second image depth comprising the seismic amplitude attribute determined at each x,y location at the second image depth;
normalizing each of the first and second seismic amplitude attribute maps;
determining a ratio map based on a ratio at each x,y location of the normalized first and second seismic amplitude attribute maps;
scaling the ratio map to generate a scale factor map;
applying, via the processor, the scale factor map to the seismic data to generate corrected seismic data that has been compensated for effects of shallow overburden attenuation; and
analyzing characteristics of the subsurface area of interest based on the corrected seismic data.

2. The method according to claim 1, wherein the seismic data comprises pre-stack seismic data.

3. The method according to claim 2, wherein the pre-stack seismic data comprises offset stacks.

4. The method according to claim 2, wherein the pre-stack seismic data comprises angle stacks.

5. The method according to claim 1, wherein the seismic data comprises post-stack seismic data.

6. The method according to claim 5, wherein the post-stack seismic data comprises offset stacks.

7. The method according to claim 5, wherein the post-stack seismic data comprises angle stacks.

8. The method according to claim 1, further comprising spatially smoothing one or both of the first and second seismic amplitude attribute maps.

9. The method according to claim 1, further comprising thresholding one or both of the normalized first and second seismic amplitude attribute maps, the ratio map and the scale factor map.

10. A system for processing seismic data corresponding to a subsurface area of interest, the system comprising:
a data source comprising the seismic data;
a computer processor in communication with the data source, the processor having access to computer readable media comprising computer readable code for processing the seismic data, including the steps of:
determining, from the seismic data, a first seismic amplitude attribute map at a first image depth comprising a seismic amplitude attribute determined at each x,y location at the first image depth;
determining, from the seismic data, a second seismic amplitude attribute map at a second image depth comprising the seismic amplitude attribute determined at each x,y location at the second image depth;
normalizing each of the first and second seismic amplitude attribute maps;
determining a ratio map based on a ratio at each x,y location of the normalized first and second seismic amplitude attribute maps;
scaling the ratio map to generate a scale factor map;
applying the scale factor map to the seismic data to generate corrected seismic data that has been compensated for effects of shallow overburden attenuation; and
analyzing characteristics of the subsurface area of interest based on the corrected seismic data.

11. The system according to claim 10, wherein the seismic data comprises pre-stack seismic data.

12. The system according to claim 11, wherein the pre-stack seismic data comprises offset stacks.

13. The system according to claim 11, wherein the pre-stack seismic data comprises angle stacks.

14. The system according to claim 10, wherein the seismic data comprises post-stack seismic data.

15. The system according to claim 14, wherein the post-stack seismic data comprises offset stacks.

16. The system according to claim 14, wherein the post-stack seismic data comprises angle stacks.

17. The system according to claim 10, wherein the computer readable media further comprises computer readable code for spatially smoothing one or both of the first and second seismic amplitude attribute maps.

18. The system according to claim 10, wherein the computer readable media further comprises computer readable code for thresholding one or more of the normalized first and second seismic amplitude attribute maps, the ratio map and the scale factor map.

19. An article of manufacture comprising a computer readable medium having a computer readable code embodied therein, the computer readable code being adapted to execute a method for seismic data processing, the method comprising:
determining, from the seismic data, a first seismic amplitude attribute map at a first image depth comprising a seismic amplitude attribute determined at each x,y location at the first image depth;
determining, from the seismic data, a second seismic amplitude attribute map at a second image depth comprising the seismic amplitude attribute determined at each x,y location at the second image depth;
normalizing each of the first and second seismic amplitude attribute maps;
determining a ratio map based on a ratio at each x,y location of the normalized first and second seismic amplitude attribute maps;
scaling the ratio map to generate a scale factor map;
applying the scale factor map to the seismic data to generate corrected seismic data that has been compensated for effects of shallow overburden attenuation; and
analyzing characteristics of the subsurface area of interest based on the corrected seismic data.

20. The article of manufacture according to claim 19, wherein the computer readable code is further adapted to execute the step spatially smoothing one or both of the first and second seismic amplitude attribute maps.

21. The article of manufacture according to claim 19, wherein the computer readable code is further adapted to execute the step thresholding one or both of the normalized first and second seismic amplitude attribute maps, the ratio map and the scale factor map.
